(19) United States
(12) Patent Application Publication
(10) Pub. No.: US 2010/0169550 A1
(43) Pub. Date: Jul. 1, 2010

(54) SEMICONDUCTOR MEMORY DEVICE, DATA TRANSFER DEVICE, AND METHOD OF CONTROLLING SEMICONDUCTOR MEMORY DEVICE

(75) Inventors: Shingo Akita, Kanagawa (JP); Hiroshi Shimizu, Kanagawa (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/547,851

(22) Filed: Aug. 26, 2009

(30) Foreign Application Priority Data
Dec. 27, 2008 (JP) 2008-335503

(51) Int. Cl. G06F 12/08; G06F 12/02

(52) U.S. Cl. 711/103; 711/118; 711/165; 711/E12.008; 711/E12.017

(57) ABSTRACT

To provide a semiconductor memory device including a first controller that controls a first data transfer in which data are transferred from the first memory to a second memory in predetermined transfer units; a second controller that controls a second data transfer in which data are transferred from the second memory to a host device; and a control unit that outputs to the first controller a read instruction in which an address in the second memory is specified for each of the predetermined transfer units and creates a descriptor in which the addresses in the second memory are specified in order of transfer. The first controller outputs an end notification at each end of the first data transfer, and the second controller executes the second data transfer according to the specification in the descriptor after receiving the end notification.

### CROSS-REFERENCE TO RELATED APPLICATIONS

This application is based upon and claims the benefit of priority from the prior Japanese Patent Application No. 2008-335503, filed on Dec. 27, 2008; the entire contents of which are incorporated herein by reference.

### BACKGROUND OF THE INVENTION

1. Field of the Invention

The present invention relates to a semiconductor memory device, a data transfer device, and a method of controlling a semiconductor memory device.

2. Description of the Related Art

As auxiliary memory devices that are used by a host device such as a personal computer to save data, there is a solid state drive (SSD) including a NAND flash memory (hereinafter, “NAND memory”) as a nonvolatile memory.

Reading of data from the NAND memory is executed for each predetermined unit size depending on how the NAND memory is configured. There are cases, however, that the size of read-requested data received by the SSD from the host device is larger than the size of a read unit (hereinafter, simply “unit size”) from the NAND memory. To read unit-sized data configuring large-sized data that is requested to read from the NAND memory and sequentially transmit the unit-sized data to the host device, the SSD includes a data transfer device having: a controller that is located on a NAND memory side and that transfers the unit-sized data from the NAND memory to a random access memory (RAM); a controller that is located on a host device side and that transfers the data stored in the RAM to the host device; and a central processing unit (CPU) that is a control unit interpreting a read request from the host device and issuing instructions for executing these data transfers to the respective controllers on the NAND memory side and the host device side.

In the data transfer device, the CPU typically executes timing control for the data transfer in an interrupting manner (as if to perform an interrupt process) for each unit-sized data. Thus, a load applied to the CPU is large, resulting in inhibiting the improvement of transfer efficiency of the data transfer device. To improve the transfer efficiency, a technique is desired for decreasing the load applied to the CPU during data transfer.

Japanese Patent Application Laid-open No. 2001-282705 discloses a technique so designed that: a host device includes a CPU and an application specific integrated circuit (ASIC); when data is transferred between the host device and a hard disk drive (HDD) being an auxiliary memory device, the CPU of the host device specifies a descriptor written with a transfer command for the ASIC; and the ASIC executes the command written in the descriptor, whereby the data transfer is controlled. According to the technique, the CPU of the host device does not need to issue commands that would usually need to be issued in a large amount, and a time required by the CPU to issue the commands can be reduced.

However, in the conventional data transfer device of the SSD that is accessed by the host device, the CPU plays a role of performing the timing control of the transfer process between the two controllers for each read unit of the NAND memory. Thus, automation of the transfer control is not easy, and the technique disclosed in Japanese Patent Application Laid-open No. 2001-282705 cannot be applied.

### BRIEF SUMMARY OF THE INVENTION

A semiconductor memory device according to an embodiment of the present invention comprises: a nonvolatile first memory; a second memory used as a cache for transferring data between the first memory and a host device; a first controller that controls a first data transfer in which data are transferred from the first memory to the second memory in predetermined transfer units; a second controller that controls a second data transfer in which data are transferred from the second memory to the host device; and a control unit that, upon receipt of a read request from the host device, outputs to the first controller a read instruction in which an address in the second memory being a transfer-destination address of the first data transfer is specified for each of the predetermined transfer units, and creates a descriptor in which the addresses in the second memory being transfer-source addresses of the second data transfer are specified in order of transfer, wherein the first controller outputs an end notification to the second controller at each end of the first data transfer, and the second controller executes the second data transfer according to the specification in the descriptor after receiving the end notification.

A data transfer device according to an embodiment of the present invention comprises: a first controller that controls a first data transfer in which data are transferred from a first memory to a second memory in predetermined transfer units; a second controller that controls a second data transfer in which data are transferred from the second memory to a host device; and a control unit that, upon receipt of a read request from the host device, outputs to the first controller a read instruction in which an address in the second memory being a transfer-destination address of the first data transfer is specified for each of the predetermined transfer units, and creates a descriptor in which the addresses in the second memory being transfer-source addresses of the second data transfer are specified in order of transfer, wherein the first controller outputs an end notification to the second controller at each end of the first data transfer, and the second controller executes the second data transfer according to the specification in the descriptor after receiving the end notification.

A method of controlling a semiconductor memory device according to an embodiment of the present invention comprises: upon receipt of a read request from a host device, outputting to a first controller a read instruction in which an address in a second memory being a transfer-destination address of a first data transfer is specified for each of predetermined transfer units and creating a descriptor in which the addresses in a second memory being transfer-source addresses of a second data transfer are specified in order of transfer; causing the first controller to output an end notification to a second controller at each end of the first data transfer; and causing the second controller to execute the second data transfer according to the specification in the descriptor after receiving the end notification.

### BRIEF DESCRIPTION OF THE DRAWINGS

FIG. 1 is a schematic diagram for explaining a configuration of a host device and an auxiliary memory device;

FIG. 2 is a schematic diagram for explaining a configuration of a data transfer device according to an embodiment of the present invention;

FIG. 3 is a schematic diagram for explaining a descriptor in detail;

FIG. 4 is a flowchart of an operation of the data transfer device according to the present embodiment; and

FIGS. 5A, 5B, and 5C are schematic diagrams for specifically explaining a way of creation of the descriptor.

### DETAILED DESCRIPTION OF THE INVENTION

Exemplary embodiments of a semiconductor memory device, a data transfer device, and a method of controlling a semiconductor memory device according to the present invention will be explained in detail below with reference to the accompanying drawings. The present invention is not limited to the embodiments.

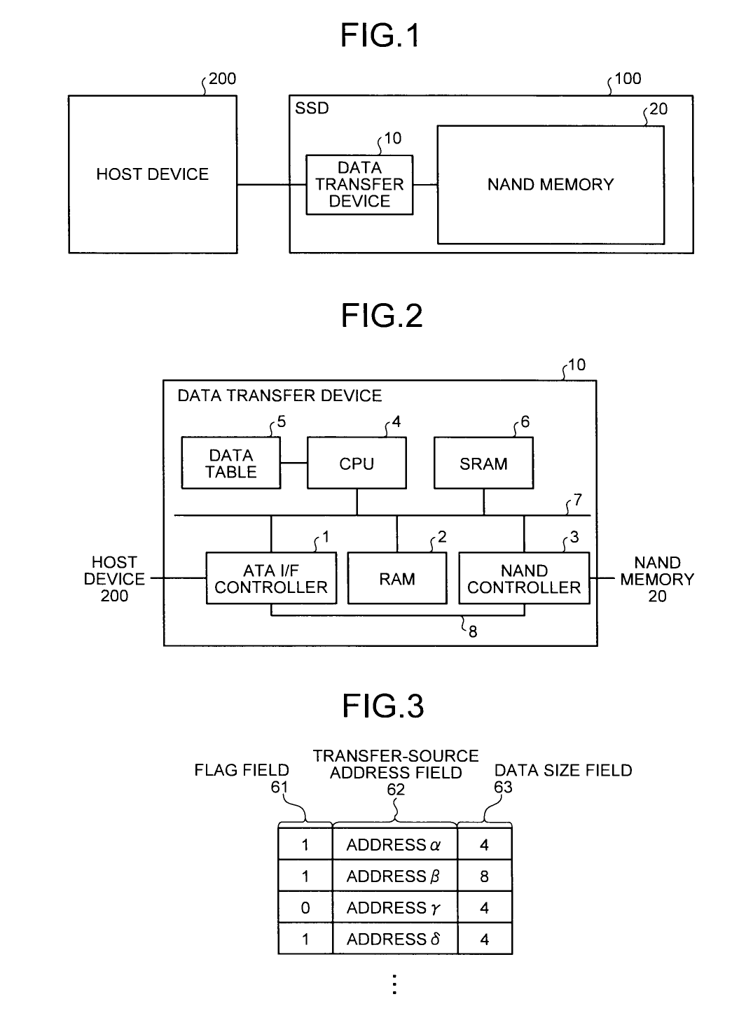

FIG. 1 is a schematic diagram for explaining a configuration of a host device and a semiconductor memory device. In an embodiment of the present invention, to explain one example of the semiconductor memory device, an SSD including a NAND flash memory as a nonvolatile memory having the same connection interface standard (advanced technology attachment (ATA) standard) as an HDD is chosen. The host device accesses the SSD by a sector unit (512 bytes, for example).

In FIG. 1, an SSD 100 and a host device 200 are connected by a communication interface of the ATA standard. Upon receipt of a data read request from the host device 200, the SSD 100 transmits read-requested data to the host device 200. The read request received by the SSD 100 from the host device 200 includes read-destination address information (for example, Logical Block Addressing (LBA)) and the size of the read-requested data. The read-requested data is one file, for example, and data having a size corresponding to the size of the file is requested to read.

The SSD 100 includes a data transfer device 10 and a NAND memory 20. Reading of data from the NAND memory 20 is executed for each predetermined unit size. The unit size is equal to a page unit being a collective write unit or a collective read unit of the NAND memory 20, for example. The page unit, which differs in size depending on each product, has sizes of 2 kilobytes, 4 kilobytes, or 8 kilobytes, for example. Based on the address information and the size of the data included in the read request received from the host device 200, the data transfer device 10 obtains an address in the NAND memory 20 of the unit-sized data configuring the read-requested data, reads the unit-sized data from the NAND memory 20 based on the obtained address, and transfers the data to the host device 200.

FIG. 2 is a schematic diagram for explaining a configuration of the data transfer device 10, which is relevant part of the embodiment. In FIG. 2, the data transfer device 10 includes an ATA interface (I/F) controller 1, a RAM 2, a NAND controller 3, a CPU 4, a data table 5, and a static RAM (SRAM) 6. The ATA I/F controller 1, the RAM 2, the NAND controller 3, the CPU 4, and the SRAM 6 are connected to one another via an internal bus 7, and the ATA I/F controller 1 and the NAND controller 3 are connected by an end-notification signal line 8.

The RAM 2 is a volatile memory used as a cache for transferring data between the host device 200 and the NAND memory 20. That is, the RAM 2 caches some of the unit-sized data stored in the NAND memory 20. It is only necessary that the RAM 2 function as a cache for transferring data, and the RAM 2 does not always need to be configured by a volatile memory. For example, a ferroelectric random access memory (FeRAM) capable of a faster operation than the NAND memory 20 can be used for the cache memory.

The data table 5 associates the read-requested data with a storage position (an address in the RAM 2 or the NAND memory 20) of each of the unit-sized data configuring the read-requested data. The data table 5 is so configured that when the address information and the data size included in the read request are used as a search key, the storage position of each unit sized data can be obtained.

The CPU 4 receives the read request received from the host device 200 via the ATA I/F controller 1 and the internal bus 7. The CPU 4 uses the address information and the data size included in the read request, as the search key, to search the data table 5, whereby the storage positions of the unit-sized data configuring the read-requested data are obtained. Based on the obtained storage positions, the CPU 4 separates the unit-sized data configuring the read-requested data into data cached in the RAM 2 and data not cached therein. The CPU 4 sequentially reads the unit-sized data not cached in the RAM 2 from the NAND memory 20, and outputs to the NAND controller 3 read instructions for sequentially storing the unit-sized data by specifying the respective write-destination addresses in the RAM 2. The CPU 4 creates a descriptor functioning as a transfer instruction for sequentially reading the data from the RAM 2 and transferring the data to the host device 200 to set the descriptor in the SRAM 7, and transmits a transfer start instruction for starting transfer based on the set descriptor via the internal bus 7 to the ATA I/F controller 1. The descriptor will be described in detail later.

The NAND controller (first controller) 3 is connected to the NAND memory 20, and based on the data read instruction from the CPU 4, reads the unit-sized data from the NAND memory 20 to store the data into the RAM 2 (first data transfer). The NAND controller 3 issues an end-notification pulse via the end-notification signal line 8 to the ATA I/F controller 1 at each completion of storage of single unit-sized data in the RAM 2.

The ATA I/F controller (second controller) 1 counts the end-notification pulses received via the end-notification signal line 8 from the NAND controller 3, and based on the descriptor set by the CPU 4 in the SRAM 6 and the count of the end-notification pulses, sequentially transfers the data stored in the RAM 2 to the host device 200 by a method that complies with the ATA standard (second data transfer).

In the SRAM 6, a plurality of descriptors are set by the CPU 4.

FIG. 3 is a schematic diagram for explaining in detail the descriptor set in the SRAM 6. In the SRAM 6, at least one descriptor is set corresponding to one read request. The descriptors each have a flag field 61, a transfer-source address field 62, and a data size field 63.

An address in the RAM 2, at which transfer-target data is stored, is written in each transfer-source address field 62, while the size of the data is written in the data size field 63. The size of the data is written as the number of data in a sector unit, which is an access unit of the host device, for example. The descriptor in the first row represents data of four sectors starting from an address α, and the descriptor in the second row represents data of eight sectors starting from an address β. The flag field 61 is a region written with a flag for determining whether the transfer-target data indicated by values in the transfer-source address field 62 and the data size field 63 is previously cached in the RAM 2. In a case of the data previously cached, “0” is written, and in a case of the data not cached, i.e., data transferred from the NAND memory 20 by the read instruction, “1” is written. For example, data of four sectors starting from an address γ, written in the descriptor in the third row, is previously cached in the RAM 2.

The descriptors set in the SRAM 6 are arranged in such a manner that the transfer-target data indicated by the values in the transfer-source address field 62 and the data size field 63 correspond to arrangement of the read-requested data. The ATA I/F controller 1 reads the descriptors in the arranged order (in this case, row by row in the order from the topmost row). When the value in the flag field 61 of the read descriptor is “0”, the ATA I/F controller 1 reads data of a size indicated by the data size field 63 of the descriptor, from the address in the RAM 2 indicated by the transfer-source data field 62 of the descriptor, and transfers the data to the host device 200. On the other hand, when the value in the flag field 61 of the read descriptor is “1”, the ATA I/F controller 1 calculates what number end-notification pulse counted is received when writing of the transfer-target data specified by the descriptor into the RAM 2 is completed. When the count of the end-notification pulses reaches the calculation result, the ATA I/F controller 1 reads the transfer-target data written in the descriptor and transfers the data to the host device 200. For example, in a case of the SSD 100 so configured that a size of four sectors (when one sector is 512 bytes, 2048 bytes=2 kilobytes) is a read unit from the NAND memory 20, it is determined that the writing of the transfer-target data specified by the descriptor into the RAM 2 is completed when a count N of the end-notification pulses reaches S/4+Ssum/4 (where S denotes the data size indicated by the data size field 63). Note that Ssum is the size of summed data transferred from the NAND memory 20 to the RAM 2 until immediately after start of writing of the transfer-target data of the descriptor into the RAM 2 since the count is reset.

The data specified as the transfer target by each descriptor is not limited to one unit-sized data. Data of a plurality of unit sizes, stored at consecutive addresses in the RAM 2 can be continuously transferred with one descriptor by writing a size worth data of the plurality of unit sizes in the data size field 63. For example, a data size of 8 (eight sectors) is written in the data size field 63 of the descriptor in the second row in FIG. 3, and “1” is written in the flag field 61. Accordingly, when the count N of the end-notification pulses reaches 8/4+Ssum/4=2+Ssum/4, the ATA I/F controller 1 determines that the writing of the transfer-target data specified by the descriptor into the RAM 2 is completed.

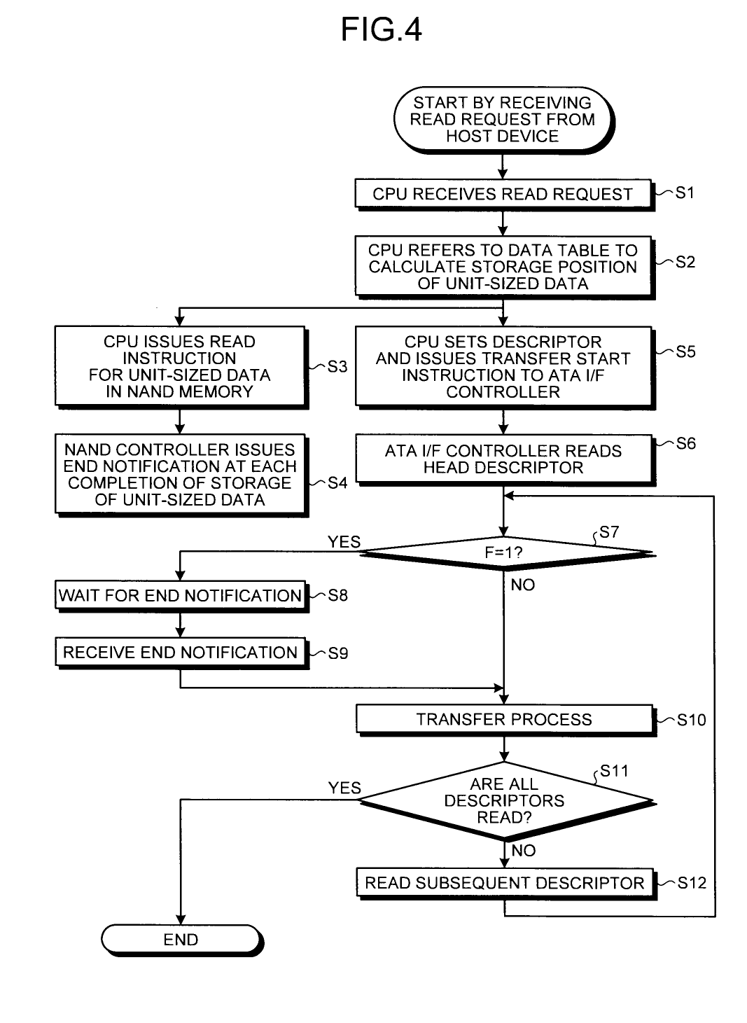

An operation of the data transfer device 10 thus configured is explained next. FIG. 4 is a flowchart of an operation of the data transfer device 10.

In FIG. 4, the SSD 100 first receives a read request from the host device 200, and when the CPU 4 of the data transfer device 10 receives the read request (Step S1), the CPU 4 searches the data table 5 for the storage position of the unit-sized data (Step S2).

After Step S2, the CPU 4 executes a process at Step S3, and in parallel therewith, executes a process at Step S5. Note that, rather than executing the processes at Steps S3 and S5 in parallel, the CPU 4 can execute the process at Step S5 after the process at Step S3.

At Step S3, the CPU 4 issues a read instruction for reading the unit-sized data stored in the NAND memory 20, to the NAND controller 3 (Step S3). The NAND controller 3 that receives the read instruction sequentially reads the data from the NAND memory 20 based on the received read instruction, stores the data into the RAM 2, and outputs the end-notification pulse to the ATA I/F controller 1 at each completion of storage of one unit-sized data into the RAM 2 (Step S4).

At Step S5, the CPU 4 creates the descriptors to set the descriptors in the SRAM 6, and outputs a transfer start instruction to the ATA I/F controller 1 (Step S5). The ATA I/F controller 1 that receives the transfer start instruction reads a head (topmost-row) descriptor (Step S6), and determines whether the value written in the flag field 61 is 1 (Step S7). When the value of the flag field 61 is 1 (YES at Step S7), the ATA I/F controller 1 shifts to a state to wait for the end-notification pulse by which the writing of the transfer-target data specified by the read descriptor is completed (Step S8). Upon receipt of the end-notification pulse (Step S9), the ATA I/F controller 1 executes a transfer process in which the transfer-target data is read from the RAM 2 and transferred to the host device 200 (Step S10). At Step S7, when the value of the flag field 61 is not 1 but 0 (NO at Step S7), the ATA I/F controller 1 immediately reads the transfer-target data from the RAM 2 and transfers the data to the host device 200 (Step S10).

After Step S10, the ATA I/F controller 1 determines whether all the descriptors are read (Step S11), and when there remains an unread descriptor (NO at Step S11), the ATA I/F controller 1 reads a subsequent descriptor (Step S12) and proceeds to Step S7. When the ATA I/F controller 1 reads and executes all the descriptors (YES at Step S11), the transfer operation is ended.

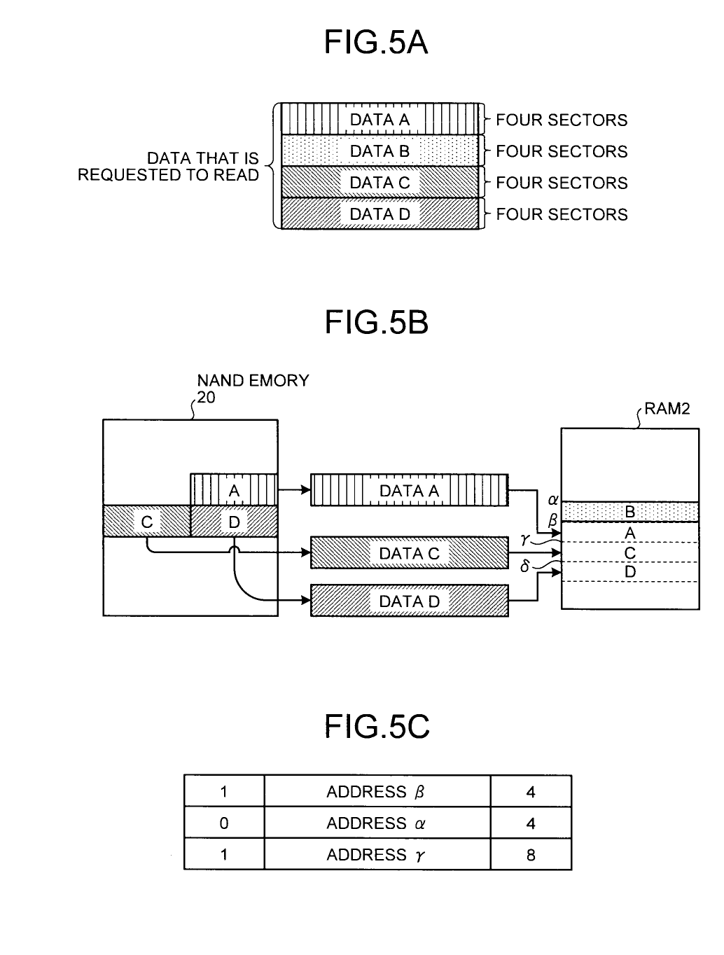

FIGS. 5A, 5B, and 5C are schematic diagrams for specifically explaining a way of creation of the descriptors based on the read request. For example, it is assumed that to the SSD 100 so configured that a size of four sectors (when one sector is 512 bytes, 2048 bytes=2 kilobytes) is a read unit (page unit) from the NAND memory 20, a file having a size of 16 sectors configured by read-unit-sized data A, B, C, and D, as shown in FIG. 5A is requested to be read from the host device 200 at Step S1 in FIG. 4. It is also assumed that, at Step S2, the CPU 4 obtains storage positions of the data A to D, and recognizes that the data B is previously stored as cache data in the address α in the RAM 2 and the other data A, C, and D are not cached in the RAM 2 but stored at predetermined addresses in the NAND memory 20, as shown in FIG. 5B. When the process proceeds to Step S3, the CPU 4 causes the data A, C, and D to be read from the respective addresses in the NAND memory 20, and issues a read instruction to the NAND controller 3 so that the data are stored at the addresses β, γ, and δ in the RAM 2, respectively.

When the process proceeds to Step S4, the NAND controller 3 sequentially reads the data A, C, and D from the NAND memory 20, and writes the data at the corresponding addresses β, γ, and δ in the RAM 2. The NAND controller 3 issues the end-notification pulse at each completion of writing of the data A, C, and D. That is, the NAND controller 3 issues a first pulse upon completion of writing of the data A, issues a second pulse upon completion of writing of the data C, and issues a third pulse upon completion of writing of the data D.

When the process proceeds to Step S5, the CPU 4 creates a descriptor that causes, after waiting for the completion of data writing, the unit-sized data A stored at the address β to be read and to be transferred to the host device 200, a descriptor that causes the unit-sized data B to be immediately read from the address α and to be transferred to the host device 200, and a descriptor that causes, after waiting for the completion of data writing, the unit-sized data C and the unit-sized data D to be continuously read from the address γ and to be transferred. The CPU 4 arranges the descriptors in this order and sets the descriptors in the SRAM 6. FIG. 5C is schematic diagram for explaining the set descriptors. At Steps S7 to S12, the ATA I/F controller 1 reads the descriptors in FIG. 5C from the topmost-row descriptor in order, and based on the read descriptor, reads the data from the RAM 2 and sequentially transfers the data to the host device 200.

More specifically, when the topmost-row descriptor is read, the ATA I/F controller 1 is placed in a state of waiting for the first end-notification pulse outputted when the writing of the data A into the RAM 2 is completed. When receiving the first end-notification pulse, the ATA I/F controller 1 reads the data A from the address β in the RAM 2 and transfers the data. When reading the descriptor in the second row, the ATA I/F controller 1 immediately reads the data B from the address α and transfers the data. When reading the descriptor in the third row, the ATA I/F controller 1 is placed in a state of waiting for the third end-notification pulse issued when the writing of the data C and D is completed. When receiving the third end-notification pulse, the ATA I/F controller 1 continuously reads the data C and D starting from the address γ in the RAM 2, and transfers the data to the host device 200.

As described above, according to the embodiment, the NAND controller 3 outputs the end notification directly to the ATA I/F controller 1 at each writing of the unit-sized data into the RAM 2. At each reception of the end notification, the ATA I/F controller 1 reads the data from the RAM 2 according to the descriptors which are created by the CPU 4 and in which the addresses of the data in the RAM 2 are specified in order of transfer, and then transfers the data to the host device 200. As a result, the CPU 4 is not involved at all in the transfer operation after the operation for issuing the read instruction for causing the NAND controller 3 to read the unit-sized data from the NAND memory 20 and store the data in the RAM 2, and the operation for creating the descriptor. Therefore, it becomes possible to provide a data transfer device in which a load applied to the CPU 4 included in the data transfer device during the data transfer is decreased as much as possible.

The RAM 2 is configured to be used as a cache for transferring data between the host device 200 and the NAND memory 20. Therefore, it is possible to decrease the frequency of reading the data from the NAND memory 20 that takes more time in reading data than the RAM 2, and accordingly, the data transfer efficiency of the data transfer device 10 can be improved.

The ATA I/F controller 1 is configured to determine whether the data transferred from the RAM 2 to the host device 200 is the cache data or the data transferred from the NAND memory 20 based on the flag set in the descriptor. This eliminates a need for the CPU 4 to execute the determination of whether to immediately read the data stored in the RAM 2 and transfer the data to the host device 200 or to wait for the data being transferred from the NAND memory 20. Therefore, it becomes possible to decrease the load applied to the CPU 4 as much as possible.

Although the NAND controller 3 and the ATA I/F controller 1 are connected by the end-notification signal line 8, i.e., a signal line dedicated to an end-notification pulse, it is possible to adopt another notifying unit that can replace the end-notification signal line 8 as long as the NAND controller 3 can transmit, without using the CPU 4, the end-notification pulse to the ATA I/F controller 1.

Although it is described that one descriptor can be intended for the plural unit-sized data stored at the consecutive addresses in the RAM 2, as a transfer target, one descriptor can be adapted to be intended only for the single unit-sized data as the transfer target.

Although how the CPU 4 outputs the read instructions to the NAND controller 3 has not been described in detail, the instructions can be outputted by any method as long as the NAND controller 3 is capable of interpreting the instructions. For example, the CPU 4 can sequentially output the read instructions for reading the single unit-sized data and writing the data in the RAM 2, or can output the read instructions in a lump.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor memory device comprising:
a nonvolatile first memory;
a second memory used as a cache for transferring data between the first memory and a host device;
a first controller that controls a first data transfer in which data are transferred from the first memory to the second memory in predetermined transfer units;
a second controller that controls a second data transfer in which data are transferred from the second memory to the host device; and
a control unit that, upon receipt of a read request from the host device, outputs to the first controller a read instruction in which an address in the second memory being a transfer-destination address of the first data transfer is specified for each of the predetermined transfer units, and creates a descriptor in which the addresses in the second memory being transfer-source addresses of the second data transfer are specified in order of transfer, wherein
the first controller outputs an end notification to the second controller at each end of the first data transfer, and the second controller executes the second data transfer according to the specification in the descriptor after receiving the end notification.

2. The semiconductor memory device according to claim 1, wherein the read instruction causes the first data transfer to be executed on data not cached in the second memory, among data that are requested to read from the host device.

3. The semiconductor memory device according to claim 2, wherein
the descriptor includes, for each of the transfer-source addresses of the second data transfer, a flag that indicates whether transfer-target data by the second data transfer is data previously cached in the second memory or data that is to be transferred from the first memory by the first data transfer, and
the second controller determines, based on the flag, whether the transfer-target data by the second data transfer is the data previously cached in the second memory or the data to be transferred from the first memory by the first data transfer, executes the second data transfer on the data cached in the second memory after obtaining the descriptor, and executes the second data transfer on the data to be transferred from the first memory by the first data transfer after obtaining the descriptor and after receiving the end notification received from the first controller.

4. The semiconductor memory device according to claim 1, wherein the first memory is a NAND flash memory, and the predetermined transfer unit is equal to a page being a collective write unit or a collective read unit of the NAND flash memory.

5. The semiconductor memory device according to claim 2, wherein the descriptor has a field that defines a data size of the transfer-target data by the second data transfer, and the second controller determines that the first data transfer corresponding to the data size is completed according to the data size and a count of the end notifications.

6. The semiconductor memory device according to claim 5, wherein in the field that defines the data size, a data size corresponding to a plurality of the predetermined transfer units can be written.

7. The semiconductor memory device according to claim 1, wherein the first controller and the second controller are connected by a dedicated line through which the end notification can be transferred as a pulse signal.

8. A data transfer device that transfers data by using a second memory as a cache for transferring data between a nonvolatile first memory and a host device, the data transfer device comprising:
a first controller that controls a first data transfer in which data are transferred from the first memory to the second memory in predetermined transfer units;
a second controller that controls a second data transfer in which data are transferred from the second memory to the host device; and
a control unit that, upon receipt of a read request from the host device, outputs to the first controller a read instruction in which an address in the second memory being a transfer-destination address of the first data transfer is specified for each of the predetermined transfer units, and creates a descriptor in which the addresses in the second memory being transfer-source addresses of the second data transfer are specified in order of transfer, wherein
the first controller outputs an end notification to the second controller at each end of the first data transfer, and the second controller executes the second data transfer according to the specification in the descriptor after receiving the end notification.

9. The data transfer device according to claim 8, wherein the read instruction causes the first data transfer to be executed on data not cached in the second memory, among data that are requested to read from the host device.

10. The data transfer device according to claim 9, wherein
the descriptor includes, for each of the transfer-source addresses of the second data transfer, a flag that indicates whether transfer-target data by the second data transfer is data previously cached in the second memory or data that is to be transferred from the first memory by the first data transfer, and
the second controller determines, based on the flag, whether the transfer-target data by the second data transfer is the data previously cached in the second memory or the data to be transferred from the first memory by the first data transfer, executes the second data transfer on the data cached in the second memory after obtaining the descriptor, and executes the second data transfer on the data to be transferred from the first memory by the first data transfer after obtaining the descriptor and after receiving the end notification received from the first controller.

11. The data transfer device according to claim 8, wherein the first memory is a NAND flash memory, and the predetermined transfer unit is equal to a page being a collective write unit or a collective read unit of the NAND flash memory.

12. The data transfer device according to claim 9, wherein the descriptor has a field that defines a data size of the transfer-target data by the second data transfer, and the second controller determines that the first data transfer corresponding to the data size is completed according to the data size and a count of the end notifications.

13. The data transfer device according to claim 12, wherein in the field that defines the data size, a data size corresponding to a plurality of the predetermined transfer units can be written.

14. The data transfer device according to claim 8, wherein the first controller and the second controller are connected by a dedicated line through which the end notification can be transferred as a pulse signal.

15. A method of controlling a semiconductor memory device that includes: a nonvolatile first memory; a second memory used as a cache for transferring data between the first memory and a host device; a first controller that controls a first data transfer in which data are transferred from the first memory to the second memory in predetermined transfer units; and a second controller that controls a second data transfer in which data are transferred from the second memory to the host device,
the method comprising:
upon receipt of a read request from the host device, outputting to the first controller a read instruction in which an address in the second memory being a transfer-destination address of the first data transfer is specified for each of the predetermined transfer units and creating a descriptor in which the addresses in the second memory being transfer-source addresses of the second data transfer are specified in order of transfer;
causing the first controller to output an end notification to the second controller at each end of the first data transfer; and
causing the second controller to execute the second data transfer according to the specification in the descriptor after receiving the end notification.

16. The method of controlling a semiconductor memory device according to claim 15, wherein the read instruction causes the first data transfer to be executed on data not cached in the second memory, among data that are requested to read from the host device.

17. The method of controlling a semiconductor memory device according to claim 16, wherein
the descriptor includes, for each of the transfer-source addresses of the second data transfer, a flag that indicates whether transfer-target data by the second data transfer is data previously cached in the second memory or data that is to be transferred from the first memory by the first data transfer, and
the second controller is caused to determine, based on the flag, whether the transfer-target data by the second data transfer is the data previously cached in the second memory or the data to be transferred from the first memory by the first data transfer, to execute the second data transfer on the data cached in the second memory after obtaining the descriptor, and to execute the second data transfer on the data to be transferred from the first memory by the first data transfer after obtaining the descriptor and after receiving the end notification received from the first controller.

18. The method of controlling a semiconductor memory device according to claim 15, wherein the first memory is a NAND flash memory, and the predetermined transfer unit is equal to a page being a collective write unit or a collective read unit of the NAND flash memory.

19. The method of controlling a semiconductor memory device according to claim 16, wherein
the descriptor has a field that defines a data size of the transfer-target data by the second data transfer, and
the second controller is caused to determine that the first data transfer corresponding to the data size is completed according to the data size and a count of the end notifications.

20. The method of controlling a semiconductor memory device according to claim 15, wherein the first controller and the second controller are connected by a dedicated line through which the end notification can be transferred as a pulse signal.
